(19) United States
(12) Patent Application Publication
(10) Pub. No.: US 2020/0372070 A1
(43) Pub. Date: Nov. 26, 2020

(54) SEARCH SYSTEM, OPERATION METHOD OF TERMINAL APPARATUS, AND PROGRAM

(71) Applicant: NEC Corporation, Tokyo (JP)

(72) Inventor: Jianquan LIU, Tokyo (JP)

(73) Assignee: NEC Corporation, Tokyo (JP)

(21) Appl. No.: 16/767,953

(22) PCT Filed: Oct. 18, 2018
(86) PCT No.: PCT/JP2018/038796

§ 371 Date: May 28, 2020

(30) Foreign Application Priority Data
Nov. 29, 2017 (JP) 2017-228772

(51) Int. Cl. G06F 16/783; G06F 16/78; G06F 16/583; G06F 16/58; G06T 7/246

(52) U.S. Cl. CPC G06F 16/7837; G06F 16/7854; G06T 7/246; G06F 16/5854; G06F 16/5866; G06F 16/7867

(57) ABSTRACT

A server (20) stores person information in which a feature of an appearance and a feature of a motion of a person extracted from a video are associated with each other, searches for the person information using input information received from a terminal apparatus (10) as a key, and returns a search result to the terminal apparatus (10). The terminal apparatus (10) acquires and stores a part or a whole of the person information stored in the server (20) from the server (20), performs a search using the input information as a key, and displays the search result on a display as a candidate of information to be input in an input field.

### TECHNICAL FIELD

The present invention relates to a search system, a server, a terminal apparatus, an operation method of a server, an operation method of a terminal apparatus, and a program.

### BACKGROUND ART

Patent Document 1 discloses a technology for inputting an approximate shape of a figure drawn on a display screen by a user, extracting an object similar to the shape of the figure drawn by the user from a database of images and objects, arranging the extracted object at a position corresponding to the figure drawn by the user, and completing and outputting one image not having awkwardness by compositing the object with a background image or the like as a drawing.

Non-Patent Document 1 discloses a video search technology based on a handwritten image. In the technology, in a case where an input of the handwritten image is received in an input field, a scene similar to the handwritten image is searched and output. In addition, a figure similar to a handwritten figure is presented as a possible input. In a case where one possible input is selected, the handwritten figure in the input field is replaced with the selected figure.

### RELATED DOCUMENT

### Patent Document

[Patent Document 1] Japanese Patent Application Publication No. 2011-2875
[Patent Document 2] International Publication No. 2014/109127
[Patent Document 3] Japanese Patent Application Publication No. 2015-49574

### Non-Patent Document

[Non-Patent Document 1] Claudiu Tanase and 7 others, “Semantic Sketch-Based Video Retrieval with Auto completion”, [Online], [Searched on Sep. 5, 2017], Internet <URL: https://iui.ku.edu.tr/sezgin_publications/2016/Sezgin-IUI-2016.pdf>

### SUMMARY OF THE INVENTION

### Technical Problem

In a case of a “scene search using only an image as a key” as disclosed in Non-Patent Document 1, search results may not be sufficiently narrowed down. An object of the present invention is to provide a technology for searching for a desired scene with high accuracy.

### Solution to Problem

According to the present invention, there is provided a search system including a terminal apparatus, and a server, in which the terminal apparatus includes a display control unit that displays an input field of a search key on a display and displays a search result on the display, an input reception unit that acquires input information input in the input field, a terminal-side transmission unit that transmits the input information to the server, and a terminal-side reception unit that receives the search result from the server, the server includes a search information storage unit that stores person information in which a feature of an appearance and a feature of a motion of a person extracted from a video are associated with each other, a server-side reception unit that receives the input information from the terminal apparatus, a first search unit that searches the search information storage unit using the input information as a key and acquires the person information including the input information, and a server-side transmission unit that transmits at least a part of the person information acquired by the first search unit to the terminal apparatus as the search result, the server or the terminal apparatus includes an input complementation data storage unit that reads and stores a part or a whole of the person information stored in the search information storage unit from the search information storage unit, and a second search unit that searches the input complementation data storage unit using the input information as a key and acquires the person information including the input information, and the display control unit displays at least a part of the person information acquired by the second search unit on the display as a candidate of information to be input in the input field.

In addition, according to the present invention, there is provided a terminal apparatus including a display control unit that displays an input field of a search key on a display and displays a search result on the display, an input reception unit that acquires input information input in the input field, a terminal-side transmission unit that transmits the input information to a server, a terminal-side reception unit that receives the search result from the server, an input complementation data storage unit that acquires and stores a part or a whole of person information which is stored in the server and in which a feature of an appearance and a feature of a motion of a person extracted from a video are associated with each other from the server, and a second search unit that searches the input complementation data storage unit using the input information as a key and acquires the person information including the input information, in which the display control unit displays at least a part of the person information acquired by the second search unit on the display as a candidate of information to be input in the input field.

In addition, according to the present invention, there is provided a server including a search information storage unit that stores person information in which a feature of an appearance and a feature of a motion of a person extracted from a video are associated with each other, a server-side reception unit that receives input information input in an input field of a search key from a terminal apparatus, a first search unit that searches the search information storage unit using the input information as a key and acquires the person information including the input information, and a server-side transmission unit that transmits at least a part of the person information acquired by the first search unit to the terminal apparatus as a search result.

In addition, according to the present invention, there is provided an operation method of a terminal apparatus executed by a computer, the method including a display control step of displaying an input field of a search key on a display and displaying a search result on the display, an input reception step of acquiring input information input in the input field, a terminal-side transmission step of transmitting the input information to a server, a terminal-side reception step of receiving the search result from the server, and a second search step of searching an input complementation data storage unit that acquires and stores a part or a whole of person information which is stored in the server and in which a feature of an appearance and a feature of a motion of a person extracted from a video are associated with each other from the server using the input information as a key, and acquiring the person information including the input information, in which in the display control step, at least a part of the person information acquired in the second search step is displayed on the display as a candidate of information to be input in the input field.

In addition, according to the present invention, there is provided a program causing a computer to function as a display control unit that displays an input field of a search key on a display and displays a search result on the display, an input reception unit that acquires input information input in the input field, a terminal-side transmission unit that transmits the input information to a server, a terminal-side reception unit that receives the search result from the server, an input complementation data storage unit that acquires and stores a part or a whole of person information which is stored in the server and in which a feature of an appearance and a feature of a motion of a person extracted from a video are associated with each other from the server, and a second search unit that searches the input complementation data storage unit using the input information as a key and acquires the person information including the input information, in which the display control unit displays at least a part of the person information acquired by the second search unit on the display as a candidate of information to be input in the input field.

In addition, according to the present invention, there is provided an operation method of a server executed by a computer, the method including a server-side reception step of receiving input information input in an input field of a search key from a terminal apparatus, a first search step of searching a search information storage unit that stores person information in which a feature of an appearance and a feature of a motion of a person extracted from a video are associated with each other using the input information as a key, and acquiring the person information including the input information, and a server-side transmission step of transmitting at least a part of the person information acquired in the first search step to the terminal apparatus as a search result.

In addition, according to the present invention, there is provided a program causing a computer to function as a search information storage unit that stores person information in which a feature of an appearance and a feature of a motion of a person extracted from a video are associated with each other, a server-side reception unit that receives input information input in an input field of a search key from a terminal apparatus, a first search unit that searches the search information storage unit using the input information as a key and acquires the person information including the input information, and a server-side transmission unit that transmits at least a part of the person information acquired by the first search unit to the terminal apparatus as a search result.

### Advantageous Effects of Invention

According to the present invention, a desired scene can be searched with high accuracy.

### BRIEF DESCRIPTION OF THE DRAWINGS

The above object, and other objects, features, and advantages will become more apparent from preferred example embodiments set forth below and the following drawings appended thereto.

FIG. 1 is a diagram illustrating one example of a function block diagram of a search system of the present example embodiment.

FIG. 2 is a diagram illustrating one example of a hardware configuration of an apparatus of the present example embodiment.

FIG. 3 is a diagram illustrating one example of a function block diagram of the search system of the present example embodiment.

FIG. 4 is a diagram schematically illustrating one example of person information of the present example embodiment.

FIG. 5 is a diagram schematically illustrating one example of the person information of the present example embodiment.

FIG. 6 is a diagram schematically illustrating one example of information displayed on a display of a terminal apparatus of the present example embodiment.

FIG. 7 is a diagram schematically illustrating one example of information displayed on the display of the terminal apparatus of the present example embodiment.

FIG. 8 is a diagram schematically illustrating one example of information displayed on the display of the terminal apparatus of the present example embodiment.

FIG. 9 is a diagram schematically illustrating one example of information displayed on the display of the terminal apparatus of the present example embodiment.

FIG. 10 is a diagram schematically illustrating one example of information displayed on the display of the terminal apparatus of the present example embodiment.

FIG. 11 is a flowchart illustrating one example of a flow of process of the search system of the present example embodiment.

FIG. 12 is a flowchart illustrating one example of the flow of process of the search system of the present example embodiment.

FIG. 13 is a diagram illustrating one example of a function block diagram of the search system of the present example embodiment.

FIG. 14 is a diagram for describing one example of a generation method of the person information of the present example embodiment.

### DESCRIPTION OF EMBODIMENTS

### First Example Embodiment

First, a summary of a search system of the present example embodiment will be described. The search system of the present example embodiment stores person information in which a feature of an appearance and a feature of a motion of a person extracted from a video are associated with each other, in a storage unit. Then, the storage unit can be searched using the feature of the appearance and the feature of the motion of the person as a key, and a person having a predetermined feature of the appearance or the motion can be extracted from the video, or a scene in which the person having the predetermined feature of the appearance or the motion is captured can be extracted. According to the search system of the present example embodiment that can search for the video using not only the feature of the appearance of the person but also the motion of the person as a key, search results can be sufficiently narrowed down, and a highly accurate search can be achieved.

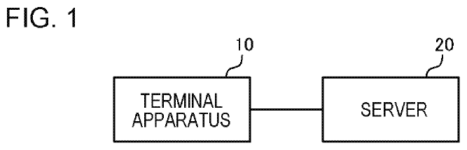

Next, a configuration of the search system of the present example embodiment will be described in detail. As illustrated in the function block diagram of FIG. 1, the search system of the present example embodiment includes a terminal apparatus 10 and a server 20. The terminal apparatus 10 and the server 20 are configured to be communicable with each other in a wired and/or wireless manner. For example, the terminal apparatus 10 and the server 20 may directly (without passing through another apparatus) communicate in a wired and/or wireless manner. Besides, for example, the terminal apparatus 10 and the server 20 may communicate in a wired and/or wireless manner through a public and/or private communication network (through another apparatus).

First, one example of hardware configurations of the terminal apparatus 10 and the server 20 will be described. Each unit included in each of the terminal apparatus 10 and the server 20 of the present example embodiment is implemented by any combination of hardware and software mainly based on a central processing unit (CPU) of any computer, a memory, a program loaded into the memory, a storage unit (can store not only a program that is stored in advance from a stage of shipment of the apparatuses but also a program that is downloaded from a storage medium such as a compact disc (CD) or a server or the like on the Internet) such as a hard disk storing the program, and a network connection interface. Those skilled in the art will perceive various modification examples of an implementation method and the apparatuses.

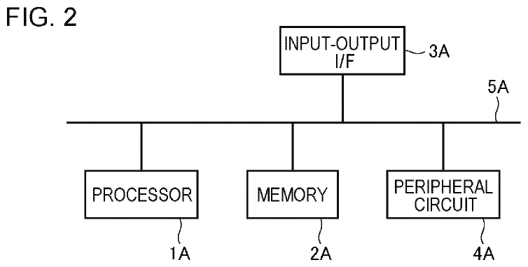

FIG. 2 is a block diagram illustrating the hardware configurations of the terminal apparatus 10 and the server 20 of the present example embodiment. As illustrated in FIG. 2, each of the terminal apparatus 10 and the server 20 includes a processor 1A, a memory 2A, an input-output interface 3A, a peripheral circuit 4A, and a bus 5A. The peripheral circuit 4A includes various modules. Note that the peripheral circuit 4A may not be included.

The bus 5A is a data transfer path for transmitting and receiving data among the processor 1A, the memory 2A, the peripheral circuit 4A, and the input-output interface 3A. The processor 1A is an arithmetic unit such as a central processing unit (CPU) or a graphics processing unit (GPU). The memory 2A is a memory such as a random access memory (RAM) or a read only memory (ROM). The input-output interface 3A includes an interface for acquiring information from an input device (example: a keyboard, a mouse, a microphone, or the like), an external apparatus, an external server, an external sensor, or the like, an interface for outputting information to an output device (example: a display, a speaker, a printer, a mailer, or the like), the external apparatus, the external server, or the like. The processor 1A can provide an instruction to each module and perform a calculation based on a calculation result of the module.

Next, a functional configuration of each of the terminal apparatus 10 and the server 20 will be described. First, a summary of a function of each apparatus will be described.

The server 20 has a search function. That is, the server 20 has a function of storing the person information in which the feature of the appearance and the feature of the motion of the person extracted from the video are associated with each other, searching for the person information using input information received from the terminal apparatus 10 as a key, and returning a search result to the terminal apparatus 10.

The terminal apparatus 10 has an input-output function. That is, the terminal apparatus 10 has a function (input-output function) of receiving an input in an input field displayed on a display, transmitting the input information that is input to the server 20 and receiving the search result from the server 20, and displaying the received search result on the display.

In addition, the terminal apparatus 10 has an input complementation function of assisting the input in the input field. That is, the terminal apparatus 10 has a function of storing input complementation information that complements the input in the input field, searching for the input complementation information using the input information input in the input field as a key, and displaying the extracted input complementation information on the display as a candidate of information to be input in the input field. In a case where any candidate is selected, the selected candidate is input in the input field as the input information.

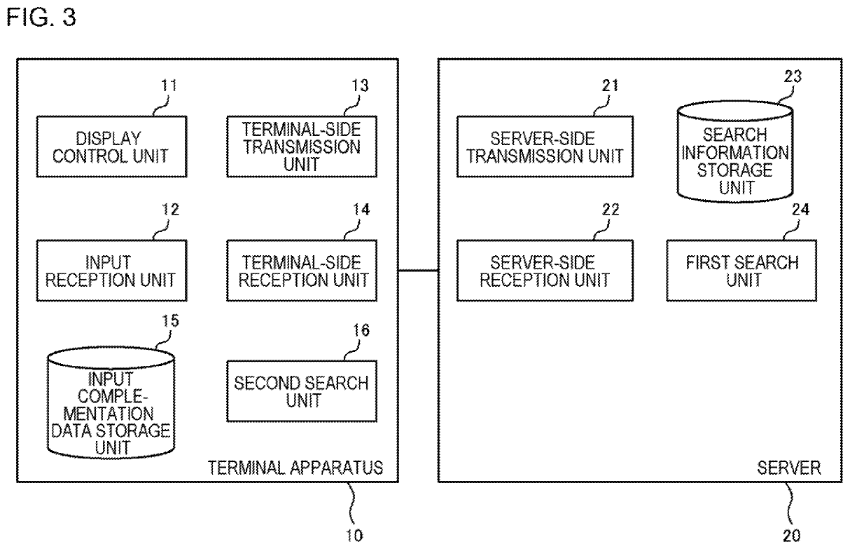

Hereinafter, the above function of each of the terminal apparatus 10 and the server 20 will be described in detail. FIG. 3 illustrates one example of a function block diagram of each of the terminal apparatus 10 and the server 20. As illustrated, the server 20 includes a server-side transmission unit 21, a server-side reception unit 22, a search information storage unit 23, and a first search unit 24. The terminal apparatus 10 includes a display control unit 11, an input reception unit 12, a terminal-side transmission unit 13, a terminal-side reception unit 14, an input complementation data storage unit 15, and a second search unit 16.

The above search function of the server 20 is implemented by the server-side transmission unit 21, the server-side reception unit 22, the search information storage unit 23, and the first search unit 24.

The search information storage unit 23 stores the person information in which the feature of the appearance and the feature of the motion of the person extracted from the video are associated with each other. The search information storage unit 23 is a non-volatile storage device (example: a hard disk drive (HDD)). The server-side reception unit 22 receives the input information input in the input field of a search key from the terminal apparatus. The first search unit 24 searches the search information storage unit 23 using the input information as a key and acquires the person information including the input information. The server-side transmission unit 21 transmits at least a part of the person information acquired by the first search unit 24 to the terminal apparatus 10 as a search result.

The input-output function of the terminal apparatus 10 is implemented by the display control unit 11, the input reception unit 12, the terminal-side transmission unit 13, and the terminal-side reception unit 14.

The display control unit 11 displays the input field of the search key on the display. The input reception unit 12 acquires the input information input in the input field of the search key. The terminal-side transmission unit 13 transmits the input information to the server 20. The terminal-side reception unit 14 receives the search result from the server. The display control unit 11 displays the search result transmitted from the server 20 on the display.

The input complementation function of the terminal apparatus 10 is implemented by the display control unit 11, the input reception unit 12, the input complementation data storage unit 15, and the second search unit 16.

The input complementation data storage unit 15 reads and stores a part or the whole of the person information stored in the search information storage unit 23 from the search information storage unit 23. The input complementation data storage unit 15 is a volatile storage device (example: a RAM). The second search unit 16 searches the input complementation data storage unit 15 using the input information as a key and acquires the person information including the input information. The display control unit 11 displays at least a part of the person information acquired by the second search unit 16 on the display as a candidate of information to be input in the input field. Note that information stored in the input complementation data storage unit 15 is the input complementation information.

Hereinafter, the search system will be described in detail using a specific example.

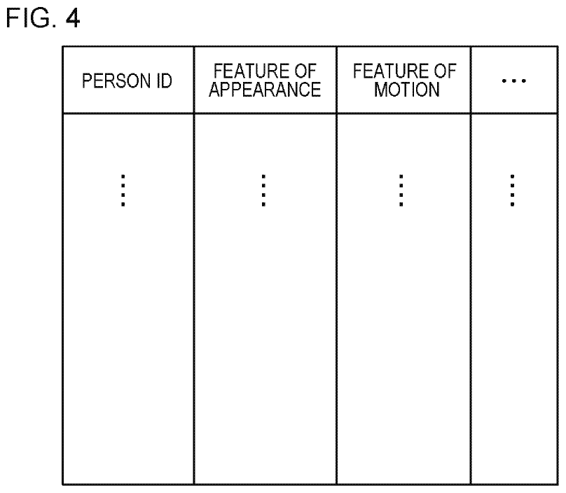

First, information stored in the search information storage unit 23 will be described in detail. FIG. 4 schematically illustrates one example of the person information. The illustrated person information associates a person identifier (ID) assigned to the person extracted from the video, the feature of the appearance of the person, and the feature of the motion of the person with each other.

The feature of the appearance of the person is illustrated by a feature of a face, a sex, an age group, a nationality, a body shape, a feature of an object worn on a body, a feature of belongings, or the like but is not for limitation purposes. For example, the feature of the face can be represented using a part of the face. Details of the feature of the face are not limited. For example, the feature of the object worn on the body is represented by a type, a color, a design, a shape, or the like such as a blue cap, black pants, a white skirt, or black high heels. For example, the feature of the belongings is represented by a type, a color, a design, or a shape like a black bag, a red umbrella, or a camouflage rucksack.

The feature of the motion is illustrated by running, walking, standing still, looking upward, sitting on a bench, a feature of a movement trajectory, or the like but is not for limitation purposes. For example, the feature of the movement trajectory may be represented by a relative relationship (example: approaching or moving away) with an object captured in an image like moving toward a predetermined target (example: a bench).

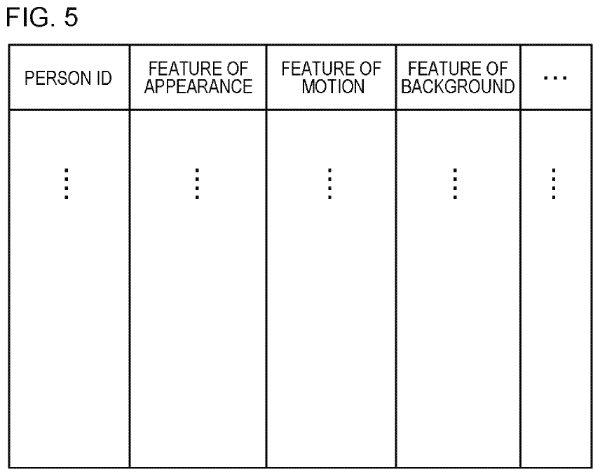

FIG. 5 schematically illustrates another example of the person information. The illustrated person information associates the person identifier (ID) assigned to the person extracted from the video, the feature of the appearance of the person, the feature of the motion of the person, and a feature of a background of the person with each other. The feature of the background is represented by an object or the like captured in the background of the extracted person like a crowd, a group of buildings, a station, a park, a bench, or a convenience store.

Note that while illustration is not provided, the person information may further include information (example: a file name) for determining a video file including a state in which each person has performed each motion, and information (example: the amount of time from a head of the video file) for determining a scene of the state. In addition, the person information may further include a still image of the scene in which each person has performed each motion.

The above person information is generated based on the video. The video may be a video that is captured by a surveillance apparatus installed on a street, or may be a video that is captured by a user using a capturing apparatus of the user. While one example of a manner of generating the person information based on the video will be described in the following example embodiment, the manner is not particularly limited in the present example embodiment.

Note that the search information storage unit 23 may further store templates of a plurality of figures. The input complementation data storage unit 15 may further read and store the templates of the figures from the search information storage unit 23. A method of using the templates will be described below.

Next, types of input information that can be received by the input reception unit 12 will be illustrated, and a specific example of a process of each function unit in a case of receiving various information will be described.

### Example 1

The input reception unit 12 acquires the input information indicating the feature of the appearance and the feature of the motion of the person. In addition, the input reception unit 12 can acquire the input information indicating the feature of the background of the person.

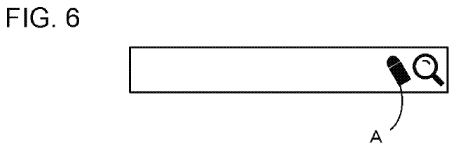

FIG. 6 illustrates one example of the input field displayed on the display by the display control unit 11. The input reception unit 12 can receive an input of the search key made through direct input of a text in the illustrated input field. For example, the input reception unit 12 may receive an input of the feature of the face, the sex, the age group, the nationality, the body shape, the feature of the object worn on the body, the feature of the belongings, the feature of the motion, or the feature of the background.

Note that the input reception unit 12 may be able to receive inputs of a plurality of words at once. In this case, a search expression in which a plurality of words are combined by a predetermined operator may be input by inputting the plurality of words in accordance with a predetermined rule. For example, the operator may be specified by a text such as and, or, or not. For example, “man and in 50s and black pants and running” is illustrated. In this case, the “man who is in his 50s and is running in black pants” is a search target, and such a person or a scene in which such a person is captured is extracted.

In addition, the input may be provided by specifying a feature of a type indicated by each word by inputting the words in accordance with a predetermined rule. For example, the type of feature may be specified by a text or a phrase before the word such that a word described after “sex:” is the sex, a word described after “age:” is the age group, and a word described after “move:” is the feature of the motion. For example, “sex: man and age: in 50s and move: running” is illustrated.

Besides, the display control unit 11 may display a graphical user interface (GUI) component such as a drop-down list or a checkbox on the display in association with various features, and the input reception unit 12 may receive the input of the search key through the GUI component.

In a case where such input information is obtained, the first search unit 24 searches the search information storage unit 23 and extracts the person information including the input information. Then, the display control unit 11 displays a list of extracted persons on the display as a search result.

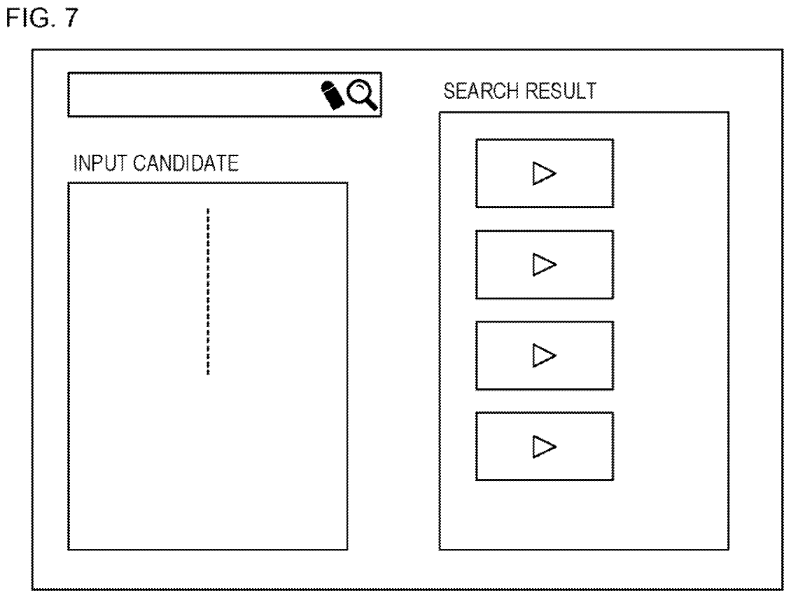

FIG. 7 illustrates one example of a screen displayed on the display. The input field is displayed in an upper left part of the screen. The search result of the first search unit 24 is shown in the right half of the screen.

In the illustrated example, a list of scenes in which the person corresponding to each person information extracted by the first search unit 24 has a corresponding motion is displayed as a search result. In a case where any one is selected, playback of the video including the scene may be started.

In addition, in a case where the input information as above is obtained, the second search unit 16 searches the input complementation data storage unit 15 and extracts the person information including the input information. Then, the display control unit 11 can display the feature included in the extracted person information on the display as a candidate of information to be input in the input field.

The feature displayed as a candidate of information to be input may be a feature of a type not included in the search expression. For example, in a case where the search expression is “man and in 50s and black pants and running”, the feature of the face, the nationality, the body shape, the feature of the belongings, the feature of the background, or the like that is a feature of a type different from the search expression may be extracted from the person information extracted by the second search unit 16 and may be displayed on the display as a candidate of information to be input in the input field. In a case of the screen example in FIG. 7, the candidate of information to be input in the input field is selectably displayed in a list below the input field.

In a case where any displayed candidate is selected, the word may be displayed in the input field. For example, in a state where “man and in 50s and black pants and running” is displayed in the input field, it is assumed that the feature of the background such as “a group of buildings, a crowd, . . . ” is displayed as a candidate of information to be input in the input field, and the “group of buildings” is selected from the candidate. In this case, the display of the input field may be changed to “man and in 50s and black pants and running and a group of buildings” depending on the selection. Then, in response to the change, for example, the first search unit 24 and the second search unit 16 may execute the search again using the new search expression, and the display of the search result of the first search unit 24 and the display of the candidate of information to be input in the input field may be switched.

### Example 2

Besides, the input reception unit 12 may receive an input of an image. For example, the image illustrates the feature of the appearance of the person or the feature of the background. For example, the user can input an image file in which a person to be searched, a person having a feature of an appearance similar to the person to be searched, a background of the person to be searched, or a background similar to the background of the person to be searched is captured.

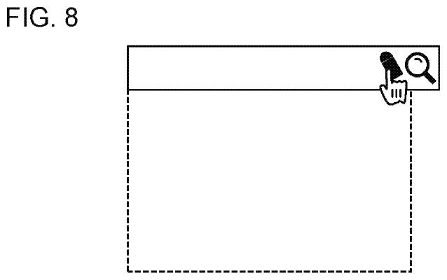

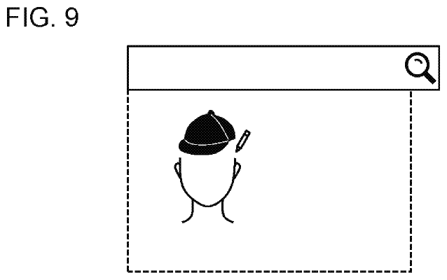

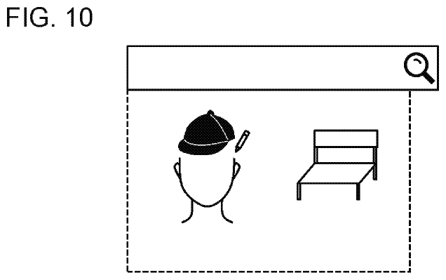

Besides, the input reception unit 12 may receive an input of handwriting an image in the input field. For example, in a case where an operation with respect to an icon A in the input field illustrated in FIG. 6 is received, the display control unit 11 may display an input field for handwriting an image on the display as illustrated in FIG. 8. A figure or the like may be drawn in the input field by handwriting as illustrated in FIG. 9 and FIG. 10.

In this case, the second search unit 16 may search the templates of the plurality of figures stored in the input complementation data storage unit 15 using the handwritten figure as a key, and may extract figures that are similar to higher than or equal to a predetermined level. Then, the display control unit 11 may display the figures extracted by the second search unit 16 on the display in a list as a candidate of information to be input in the input field. In this case, in a case where any candidate is selected, the handwritten figure displayed in the input field is replaced with the selected figure. Note that timings of the execution of the search by the second search unit 16 and the display of the candidate by the display control unit 11 are design matters. The search and the display of the candidate may be executed at any time in the middle of drawing the figure using the figure being drawn in the input field at the time as the input information.

In a case of the example, the input reception unit 12 may receive an input of the feature of the motion in the same manner as Example 1. That is, the input reception unit 12 may receive the input of the feature of the motion made through direct input of a text in the input field.

Besides, the input reception unit 12 may receive the input of the feature of the motion by receiving a predetermined operation with respect to an image (figure) displayed in the input field. For example, as illustrated in FIG. 10, in a state where a person and a bench (background) are displayed in the input field, a feature of a motion of “moving toward the bench” may be input in a case where a drag & drop operation of moving the person to the bench by dragging and dropping the person is received.

In this case, the second search unit 16 searches the input complementation data storage unit 15 using the input information (an image, a word, or the like) input in the input field at the time as a key, and extracts the person information including the input information. Then, the display control unit 11 may display guidance of an input operation (the drag & drop operation or the like) corresponding to the feature of the motion included in the extracted person information on the display. For example, guidance of the drag & drop operation of moving the person to the bench by dragging and dropping the person may be provided by displaying in the input field an arrow directed from the person toward the bench in the input field illustrated in FIG. 10.

Besides, for example, in a case where a predetermined operation (example: a right click on the icon on the image) with respect to the person displayed in the input field is received, the display control unit 11 may display a GUI component such as a drop-down list or a checkbox for selecting the feature of the motion on the display. Then, the input reception unit 12 may receive an input of selecting the feature of the motion from the GUI component.

In this case, the second search unit 16 searches the input complementation data storage unit 15 using the input information (an image, a word, or the like) input in the input field at the time as a key, and extracts the person information including the input information. Then, the display control unit 11 displays a GUI component such as a drop-down list or a checkbox including the feature of the motion included in the extracted person information as an option. Note that in the search using the image as a key, the person information that is similar to the image of the input information to higher than or equal to a predetermined level may be extracted. For example, a similarity between the appearance of the person in a “still image of the scene in which each person has performed each motion” included in the person information and the image of the person of the input information may be determined, and the person information corresponding to a still image including a person who is similar to the image of the input information to higher than or equal to a predetermined level may be extracted. Besides, a similarity between the background of the person in the “still image of the scene in which each person has performed each motion” included in the person information and the image (example: the bench in FIG. 10) of the background of the input information may be determined, and the person information corresponding to a still image (example: a still image including a bench similar to the bench in FIG. 10 to higher than or equal to a predetermined level in the background) including a part similar to the image of the input information to higher than or equal to a predetermined level in the background may be extracted.

The first search unit 24 can search the search information storage unit 23 using the input information input in the input field as a key and can extract the person information including the input information in the same manner as Example 1. Then, the display control unit 11 can display the list of extracted person information on the display as a search result. In addition, the second search unit 16 can search the input complementation data storage unit 15 using the input information input in the input field as a key and can extract the person information including the input information in the same manner as Example 1.

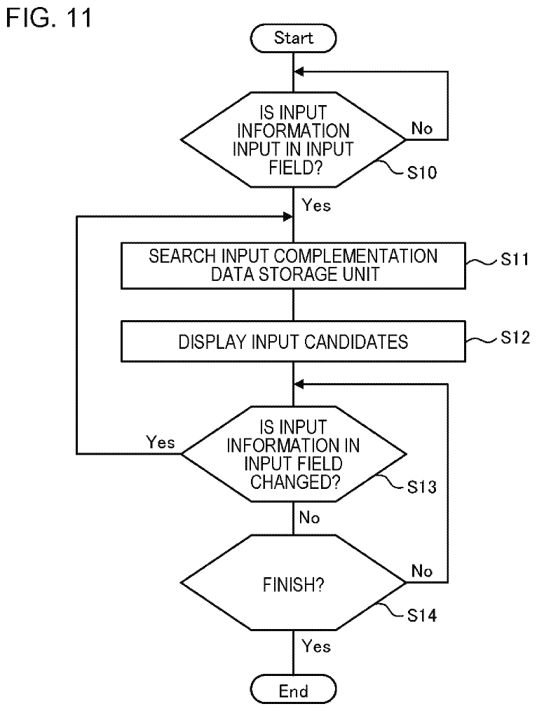

Next, one example of a flow of process of displaying input complementation data will be described using FIG. 11.

In a case where the input information is input in the input field (Yes in S10), the second search unit 16 searches the input complementation data storage unit 15 (S11). Then, the display control unit 11 displays the candidate of information to be input in the input field on the display, based on the search result of the second search unit 16 (S12).

Then, in a case where the input information input in the input field is changed (Yes in S13), the processes of S11 and S12 are repeated.

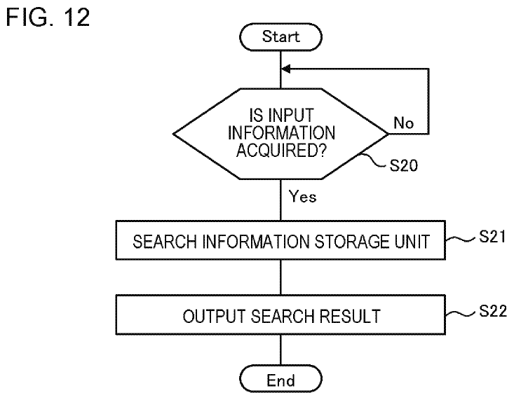

Next, one example of a flow of search process of the server 20 will be described using FIG. 12.

In a case where the server-side reception unit 22 acquires the input information from the terminal apparatus 10 (Yes in S20), the first search unit 24 searches the search information storage unit 23 (S21). Then, the server-side transmission unit 21 transmits the search result to the terminal apparatus 10 (S22).

The search system of the present example embodiment described above can perform a search using the feature of the appearance and the feature of the motion of the person as a key and extract a person having a predetermined feature (the feature of the appearance and the feature of the motion) from the video or extract a scene in which the person having the predetermined feature is captured. According to the search system of the present example embodiment that can search for the video using not only the feature of the appearance of the person but also the motion as a key, search results can be sufficiently narrowed down, and a highly accurate search can be achieved.

In addition, according to the search system of the present example embodiment, the user can input an image as a search key. The input manner is highly convenient for a user who may not easily convert the appearance of the person or the feature of the background which the user imagines into a text.

In addition, according to the search system of the present example embodiment, a part or the whole of the person information stored in the search information storage unit 23 can be stored in the input complementation data storage unit 15. The candidate of information to be input in the input field can be decided based on the person information stored in the input complementation data storage unit 15 and information input in the input field thus far, and can be provided to the user. According to the search system of the present example embodiment, the input of the user can be assisted. In addition, since the candidate of information to be input is decided based on the person information stored in the search information storage unit 23, the information is useful information for narrowing the search results down.

### Second Example Embodiment

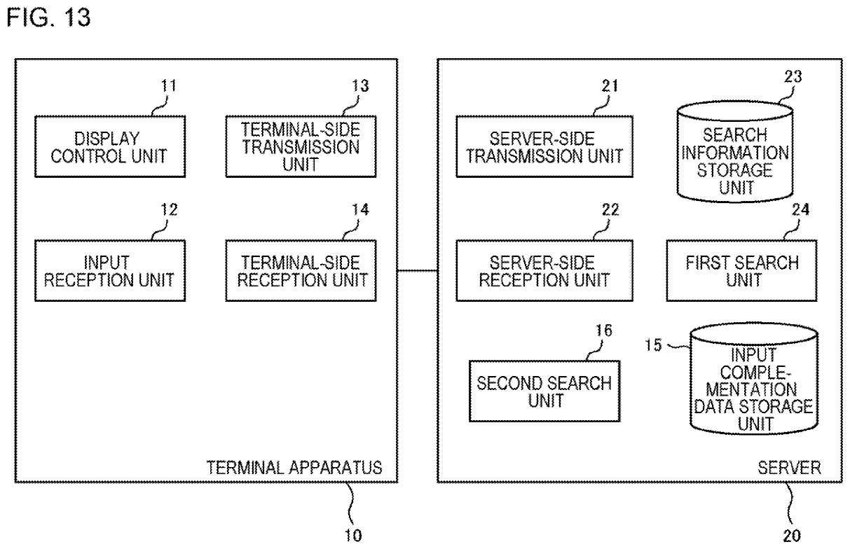

FIG. 13 illustrates one example of a function block diagram of a search system of the present example embodiment. The present example embodiment is different from the first example embodiment in that the server 20 includes the input complementation data storage unit 15 and the second search unit 16, and the terminal apparatus 10 does not include the input complementation data storage unit 15 and the second search unit 16.

In the present example embodiment, the terminal apparatus 10 transmits information to be used for the search performed by the second search unit 16 to the server 20, and acquires the search result of the second search unit 16 from the server 20.

According to the search system of the present example embodiment, the same advantageous effect as the search system of the first example embodiment can be achieved.

### Third Example Embodiment

The present example embodiment provides one example of a creation method of the person information stored in the search information storage unit 23. The following process may be performed by the server 20 or may be performed by an apparatus different from the server 20.

First, a person is extracted from each of a plurality of frames. Then, a determination as to whether or not a person extracted from a certain frame is the same person as a person extracted from the previous frame is performed, and the same persons are grouped. The determination may also be performed by comparing all pairs of the feature of the appearance of each of all persons extracted from the previous frame and the feature of the appearance of each of all persons extracted from the certain frame. However, in a case of this process, as accumulated data of the person is increased, the number of pairs to be compared is significantly increased, and a process load is increased. Therefore, for example, the following method may be employed.

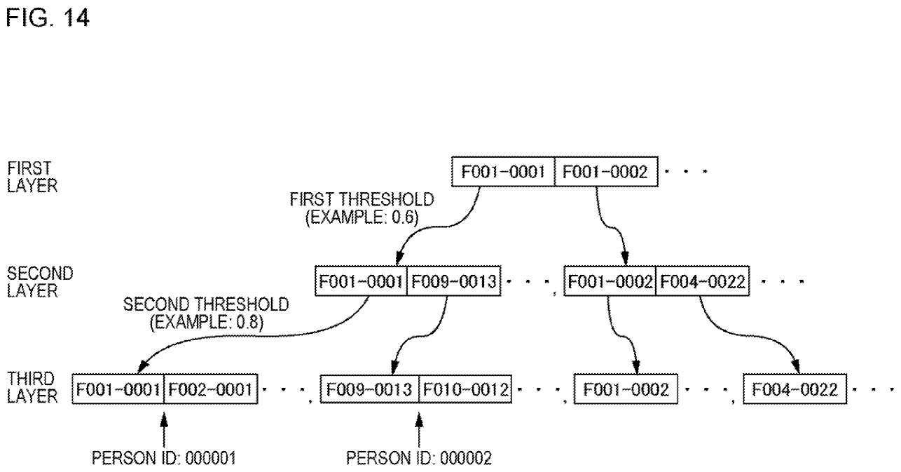

For example, the extracted person may be indexed as illustrated in FIG. 14, and a determination as to whether or not the person is the same person as the previously extracted person may be performed using the index. A processing speed can be increased by using the index. Details and a generation method of the index are disclosed in Patent Documents 2 and 3 and will be briefly described below.

An extraction identifier (ID): “F000-0000” illustrated in FIG. 14 is identification information that is assigned to each person extracted from each frame. F000 is frame identification information, and the part after the hyphen is identification information of each person extracted from each frame. In a case where the same person is extracted from different frames, different extraction IDs are assigned to the person in each frame.

In a third layer, a node that corresponds to each of all extraction IDs obtained from the frames processed thus far is arranged. Among the plurality of nodes arranged in the third layer, nodes having a similarity (a similarity of a feature value of the appearance) of higher than or equal to a first level are grouped. In the third layer, a plurality of extraction IDs that are determined as being related to the same person are grouped. That is, the first level of the similarity is set to a value that can implement such grouping. Person identification information (person ID) is assigned to each group of the third layer.

In a second layer, one node (representative) that is selected from each of the plurality of groups of the third layer is arranged and is linked to the group of the third layer. Among the plurality of nodes arranged in the second layer, nodes having the similarity of higher than or equal to a second level are grouped. Note that the second level of the similarity is lower than the first level. That is, nodes that are not grouped in a case where the first level is used as a reference may be grouped in a case where the second level is used as a reference.

In a first layer, one node (representative) that is selected from each of the plurality of groups of the second layer is arranged and is linked to the group of the second layer.

In a case where a new extraction ID is obtained from a new frame, first, the plurality of extraction IDs positioned in the first layer are used as a comparison target. That is, pairs are created between the new extraction ID and each of the plurality of extraction IDs positioned in the first layer. Then, the similarity (the similarity of the feature value of the appearance) is computed for each pair, and a determination as to whether or not the computed similarity is higher than or equal to a first threshold (similar to higher than or equal to the predetermined level) is performed.

In a case where the extraction ID having the similarity of higher than or equal to the first threshold is not present in the first layer, it is determined that a person corresponding to the new extraction ID is not the same person as the person previously extracted. Then, the new extraction ID is added to the first layer to the third layer, and the extraction IDs are linked to each other. In the second layer and the third layer, a new group is generated by the added new extraction ID. In addition, a new person ID is issued in association with the new group of the third layer. The person ID is determined as a person ID of the person corresponding to the new extraction ID.

On the other hand, in a case where the extraction ID having the similarity of higher than or equal to the first threshold is present in the first layer, the comparison target is moved to the second layer. Specifically, a group of the second layer that is linked to the “extraction ID of the first layer determined as having the similarity of higher than or equal to the first threshold” is used as the comparison target.

Then, pairs are created between the new extraction ID and each of the plurality of extraction IDs included in the processing target group of the second layer. Next, the similarity is computed for each pair, and a determination as to whether or not the computed similarity is higher than or equal to a second threshold is performed. Note that the second threshold is higher than the first threshold.

In a case where the extraction ID having the similarity of higher than or equal to the second threshold is not present in the processing target group of the second layer, it is determined that the person corresponding to the new extraction ID is not the same person as the person previously extracted. Then, the new extraction ID is added to the second layer and the third layer, and the extraction IDs are linked to each other. In the second layer, the new extraction ID is added to the processing target group. In the third layer, a new group is generated by the added new extraction ID. In addition, a new person ID is issued in association with the new group of the third layer. The person ID is determined as a person ID of the person corresponding to the new extraction ID.

On the other hand, in a case where the extraction ID having the similarity of higher than or equal to the second threshold is present in the processing target group of the second layer, it is determined that the person corresponding to the new extraction ID is the same person as the person previously extracted. Then, the new extraction ID is set to belong to a group of the third layer that is linked to the “extraction ID of the second layer determined as having the similarity of higher than or equal to the second threshold”. In addition, a person ID corresponding to the group of the third layer is determined as a person ID of the person corresponding to the new extraction ID.

For example, as described above, one or a plurality of extraction IDs extracted from a new frame can be added to the index in FIG. 14, and the person ID can be associated with each extraction ID.

The feature of the appearance and the feature of the motion of each person, and the feature of the background may be generated by a process performed by a computer, or may be input into the computer by causing a person to visually recognize the video and determine various features. In a case of the process performed by the computer, the process can be implemented using any technology.

According to the search system of the present example embodiment, the same advantageous effect as the first and second example embodiments can be achieved.

Reference embodiments are appended below.

1. A search system including a terminal apparatus, and a server, in which the terminal apparatus includes a display control unit that displays an input field of a search key on a display and displays a search result on the display, an input reception unit that acquires input information input in the input field, a terminal-side transmission unit that transmits the input information to the server, and a terminal-side reception unit that receives the search result from the server, the server includes a search information storage unit that stores person information in which a feature of an appearance and a feature of a motion of a person extracted from a video are associated with each other, a server-side reception unit that receives the input information from the terminal apparatus, a first search unit that searches the search information storage unit using the input information as a key and acquires the person information including the input information, and a server-side transmission unit that transmits at least a part of the person information acquired by the first search unit to the terminal apparatus as the search result, the server or the terminal apparatus includes an input complementation data storage unit that reads and stores a part or a whole of the person information stored in the search information storage unit from the search information storage unit, and a second search unit that searches the input complementation data storage unit using the input information as a key and acquires the person information including the input information, and the display control unit displays at least a part of the person information acquired by the second search unit on the display as a candidate of information to be input in the input field.

2. The search system according to 1, in which the input reception unit acquires the input information indicating the feature of the appearance and the feature of the motion of the person.

3. The search system according to 2, in which the input reception unit acquires an image as the input information indicating the feature of the appearance of the person.

4. The search system according to any one of 1 to 3, in which the person information further includes a feature of a background.

5. The search system according to 4, in which the input reception unit acquires the input information indicating the feature of the background.

6. The search system according to 5, in which the input reception unit acquires an image as the input information indicating the feature of the background.

7. The search system according to 3 or 6, in which the input reception unit acquires the image that is input by handwriting in the input field.

8. The search system according to any one of 1 to 7, in which the person information further includes image data indicating a state where each person has performed each motion.

9. A terminal apparatus including a display control unit that displays an input field of a search key on a display and displays a search result on the display, an input reception unit that acquires input information input in the input field, a terminal-side transmission unit that transmits the input information to a server, a terminal-side reception unit that receives the search result from the server, an input complementation data storage unit that acquires and stores a part or a whole of person information which is stored in the server and in which a feature of an appearance and a feature of a motion of a person extracted from a video are associated with each other from the server, and a second search unit that searches the input complementation data storage unit using the input information as a key and acquires the person information including the input information, in which the display control unit displays at least a part of the person information acquired by the second search unit on the display as a candidate of information to be input in the input field.

10. A server including a search information storage unit that stores person information in which a feature of an appearance and a feature of a motion of a person extracted from a video are associated with each other, a server-side reception unit that receives input information input in an input field of a search key from a terminal apparatus, a first search unit that searches the search information storage unit using the input information as a key and acquires the person information including the input information, and a server-side transmission unit that transmits at least a part of the person information acquired by the first search unit to the terminal apparatus as a search result.

11. The server according to 10, further including an input complementation data storage unit that reads and stores a part or a whole of the person information stored in the search information storage unit from the search information storage unit, and a second search unit that searches the input complementation data storage unit using the input information as a key and acquires the person information including the input information.

12. An operation method of a terminal apparatus executed by a computer, the method including a display control step of displaying an input field of a search key on a display and displaying a search result on the display, an input reception step of acquiring input information input in the input field, a terminal-side transmission step of transmitting the input information to a server, a terminal-side reception step of receiving the search result from the server, and a second search step of searching an input complementation data storage unit that acquires and stores a part or a whole of person information which is stored in the server and in which a feature of an appearance and a feature of a motion of a person extracted from a video are associated with each other from the server using the input information as a key, and acquiring the person information including the input information, in which in the display control step, at least a part of the person information acquired in the second search step is displayed on the display as a candidate of information to be input in the input field.

13. A program causing a computer to function as a display control unit that displays an input field of a search key on a display and displays a search result on the display, an input reception unit that acquires input information input in the input field, a terminal-side transmission unit that transmits the input information to a server, a terminal-side reception unit that receives the search result from the server, an input complementation data storage unit that acquires and stores a part or a whole of person information which is stored in the server and in which a feature of an appearance and a feature of a motion of a person extracted from a video are associated with each other from the server, and a second search unit that searches the input complementation data storage unit using the input information as a key and acquires the person information including the input information, in which the display control unit displays at least a part of the person information acquired by the second search unit on the display as a candidate of information to be input in the input field.

14. An operation method of a server executed by a computer, the method including a server-side reception step of receiving input information input in an input field of a search key from a terminal apparatus, a first search step of searching a search information storage unit that stores person information in which a feature of an appearance and a feature of a motion of a person extracted from a video are associated with each other using the input information as a key, and acquiring the person information including the input information, and a server-side transmission step of transmitting at least a part of the person information acquired in the first search step to the terminal apparatus as a search result.

15. A program causing a computer to function as a search information storage unit that stores person information in which a feature of an appearance and a feature of a motion of a person extracted from a video are associated with each other, a server-side reception unit that receives input information input in an input field of a search key from a terminal apparatus, a first search unit that searches the search information storage unit using the input information as a key and acquires the person information including the input information, and a server-side transmission unit that transmits at least a part of the person information acquired by the first search unit to the terminal apparatus as a search result.

This application claims the benefit of priority based on Japanese Patent Application No. 2017-228772 filed on Nov. 29, 2017, the entire disclosure of which is incorporated herein.

1. A search system comprising:
a terminal apparatus; and
a server,
wherein the terminal apparatus comprises
a display control unit that displays an input field of a search key on a display and displays a search result on the display,
an input reception unit that acquires input information input in the input field,
a terminal-side transmission unit that transmits the input information to the server, and
a terminal-side reception unit that receives the search result from the server,
the server comprises
a search information storage unit that stores person information in which a feature of an appearance and a feature of a motion of a person extracted from a video are associated with each other,
a server-side reception unit that receives the input information from the terminal apparatus,
a first search unit that searches the search information storage unit using the input information as a key and acquires the person information including the input information, and
a server-side transmission unit that transmits at least a part of the person information acquired by the first search unit to the terminal apparatus as the search result,
the server or the terminal apparatus comprises
an input complementation data storage unit that reads and stores a part or a whole of the person information stored in the search information storage unit from the search information storage unit, and
a second search unit that searches the input complementation data storage unit using the input information as a key and acquires the person information including the input information, and
the display control unit displays at least a part of the person information acquired by the second search unit on the display as a candidate of information to be input in the input field.

2. The search system according to claim 1,
wherein the input reception unit acquires the input information indicating the feature of the appearance and the feature of the motion of the person.

3. The search system according to claim 2,
wherein the input reception unit acquires an image as the input information indicating the feature of the appearance of the person.

4. The search system according to claim 1,
wherein the person information further includes a feature of a background.

5. The search system according to claim 4,
wherein the input reception unit acquires the input information indicating the feature of the background.

6. The search system according to claim 5,
wherein the input reception unit acquires an image as the input information indicating the feature of the background.

7. The search system according to claim 3,
wherein the input reception unit acquires the image that is input by handwriting in the input field.

8. The search system according to claim 1,
wherein the person information further includes image data indicating a state where each person has performed each motion.

9-11. (canceled)

12. An operation method of a terminal apparatus executed by a computer, the method comprising:
a display control step of displaying an input field of a search key on a display and displaying a search result on the display;
an input reception step of acquiring input information input in the input field;
a terminal-side transmission step of transmitting the input information to a server;
a terminal-side reception step of receiving the search result from the server; and
a second search step of searching an input complementation data storage unit that acquires and stores a part or a whole of person information which is stored in the server and in which a feature of an appearance and a feature of a motion of a person extracted from a video are associated with each other from the server using the input information as a key, and acquiring the person information including the input information,
wherein in the display control step, at least a part of the person information acquired in the second search step is displayed on the display as a candidate of information to be input in the input field.

13. A non-transitory storage medium storing a program causing a computer to function as:
a display control unit that displays an input field of a search key on a display and displays a search result on the display;
an input reception unit that acquires input information input in the input field;
a terminal-side transmission unit that transmits the input information to a server;
a terminal-side reception unit that receives the search result from the server;
an input complementation data storage unit that acquires and stores a part or a whole of person information which is stored in the server and in which a feature of an appearance and a feature of a motion of a person extracted from a video are associated with each other from the server; and
a second search unit that searches the input complementation data storage unit using the input information as a key and acquires the person information including the input information,
wherein the display control unit displays at least a part of the person information acquired by the second search unit on the display as a candidate of information to be input in the input field.

14-15. (canceled)
